(19) United States
(12) Patent Application Publication
(10) Pub. No.: US 2025/0291131 A1
(43) Pub. Date: Sep. 18, 2025

(54) Multimodal Microscope and Microscopy Method

(71) Applicant: Carl Zeiss Microscopy GmbH, Jena (DE)

(72) Inventors: Richard Hollinger, Jena (DE); Ralf Netz, Jena (DE); Joerg Siebenmorgen, Jena (DE)

(21) Appl. No.: 19/078,470

(22) Filed: Mar. 13, 2025

(30) Foreign Application Priority Data
Mar. 13, 2024 (DE) 10 2024 107 200.8

(51) Int. Cl. G02B 6/42; G02B 15/15; G02B 21/24

(52) U.S. Cl. CPC G02B 6/422; G02B 15/15; G02B 21/241

(57) ABSTRACT

A multimodal microscope having a light source for transmitting excitation light, an illumination beam path having a microscope objective for guiding the excitation light onto and/or into a sample, at least one first spatial light modulator being present in the illumination beam path for manipulating the excitation light, a detector for detecting detection light emitted by the sample owing to illumination with the excitation light, a detection beam path, comprising the microscope objective or a further microscope objective, for guiding the detection light onto the detector, and a controller at least for controlling the first spatial light modulator. The multimodal microscope includes a switchable optical functional group, which is switchable at least into a first and a second switching state, and the first spatial light modulator is situated either in or in the vicinity of an intermediate image plane or a pupil plane of the illumination beam path, depending on the switching state.

The current application claims the benefit of German Patent Application No. 10 2024 107 200.8, filed on 13 Mar. 2024, which is hereby incorporated by reference.

The invention relates to a multimodal microscope according to the preamble of Claim 1 and a method for microscopy according to the preamble of Claim 17.

A generic multimodal microscope has at least the following component parts: a light source for transmitting excitation light, an illumination beam path having a microscope objective for guiding the excitation light onto and/or into a sample to be examined, at least one first spatial light modulator being present in the illumination beam path for the purpose of manipulating the excitation light, a detector for detecting detection light emitted by the sample owing to illumination with the excitation light, a detection beam path, comprising the microscope objective or a further microscope objective, for guiding the detection light onto the detector, and a controller at least for controlling the first spatial light modulator.

In a generic method for microscopy, at least the following method steps are carried out: excitation light is guided onto and/or into a sample to be examined, via an illumination beam path having a microscope objective, the excitation light is manipulated at least by a first spatial light modulator in the illumination beam path, detection light emitted by the sample owing to illumination with the excitation light is guided onto a detector via a detection beam path comprising the microscope objective or a further microscope objective and is detected by said detector.

Generic microscopes and generic methods are known in many configurations and variants, for example from DE 10 2022 103 051 A1.

In microscopy, it is known to suitably condition excitation light for a microscopic technique respectively desired, in an illumination beam path using spatial light modulators (SLM=Spatial Light Modulator), which can be arranged in a pupil plane or an intermediate image plane of the illumination beam path. In particular, it is known, for the purpose of realizing various microscopy methods, to adjust the phase of the excitation light in an intermediate image plane and/or in a pupil plane in a respectively desired manner. Also known are microscopes in which, in principle, a plurality of different microscopy methods can be carried out using one and the same device [20], [21]. In that case the microscopy methods may also be referred to as microscopy techniques or microscopy modes. In order to change from one microscopy mode to another, the known microscopes require comparatively costly modification measures, however, at any rate for some pairs of microscopy modes between which switching is intended to be effected.

An object of the invention can be considered that of providing a multimodal microscope of the type specified above which is suitable for carrying out many different microscopy methods. Moreover, a method for microscopy which can be implemented in many variants is intended to be specified. Changing or switching between the methods is intended to be as simple as possible in this case.

This object is achieved by means of the multimodal microscope having the features of Claim 1 and by means of the method for microscopy having the features of Claim 17.

According to the invention, the multimodal microscope of the type specified above is developed further in that a switchable optical functional group is present, which is switchable at least into a first switching state and into a second switching state, and in that the first spatial light modulator is situated either in an intermediate image plane or in the vicinity of an intermediate image plane of the illumination beam path or in a pupil plane or in the vicinity of a pupil plane of the illumination beam path, depending on which switching state the optical functional group is in.

According to the invention, the method of the type specified above is developed further in that a switchable optical functional group is switched either into a first switching state or into a second switching state before microscope measurements are carried out, the first spatial light modulator, depending on the switching state into which the optical functional group is switched, being situated either in an intermediate image plane or in the vicinity of an intermediate image plane of the illumination beam path or in a pupil plane or in the vicinity of a pupil plane of the illumination beam path, and in that afterwards at least one of the spatial light modulators is controlled for the purpose of providing a desired illumination mode.

Preferred exemplary embodiments of the microscope according to the invention and advantageous variants of the method according to the invention are explained below, in particular in association with the dependent claims and the figures.

The multimodal microscope according to the invention can be configured in particular for carrying out the method for microscopy according to the invention. The method according to the invention can be carried out in particular by the multimodal microscope according to the invention.

An essential concept of the present invention can be considered that of keeping available a switchable component in the illumination beam path, said switchable component allowing that position at which the first spatial light modulator is arranged to be switched in each case optionally to the function of a pupil plane or of an intermediate image plane. In the present application, this switchable component is referred to as an optical functional group.

In more complex variants, this optical functional group can serve optionally in each case to adjust the function of a pupil plane or of an intermediate image plane for further positions, too, at which further spatial light modulators are arranged, for example a position at which a second spatial light modulator is arranged.

The present invention provides a multimodal microscope which is adjustable for carrying out many different microscopy modes, switching between the different microscopy modes being able to be effected in a simple manner in each case. In essence only an actuation of the optical functional group and the selection of suitable control for the first and/or if appropriate further spatial light modulators will be necessary for this purpose. The method for microscopy according to the invention can likewise be carried out in numerous configurations and changing between these can easily be done. The device-related outlay and complexity are comparatively low in this case.

As a light source for the microscope according to the invention, in essence lasers are conceivable, but other light sources are also possible. The excitation light is electromagnetic radiation preferably in the visible range and adjoining ranges. With regard to the samples to be examined, there is no restriction, in principle. The samples to be examined will often be biological samples.

The term illumination beam path denotes all optical beam-guiding and beam-modifying components, for example a microscope objective, lenses, mirrors, prisms, gratings, filters, stops, beam splitters, modulators, for example spatial light modulators (SLM), by means of which and via which the excitation light from the light source is guided to the sample to be examined. Beam-modifying components also encompass dispersive and in particular diffractive elements. Commercially available microscope objectives can be used, in principle.

Manipulating the excitation light in the illumination beam path by means of the first spatial light modulator or if appropriate further spatial light modulators, in particular a second light modulator, can serve in particular to provide a desired illumination mode.

The first spatial light modulator can be, in principle, the sole spatial light modulator in the illumination beam path. However, it is also possible for a second spatial light modulator to be arranged in the illumination beam path, which is situated in or in the vicinity of a pupil plane when the first spatial light modulator is situated in or in the vicinity of an intermediate image plane, and which is situated in or in the vicinity of an intermediate image plane when the first spatial light modulator is situated in or in the vicinity of a pupil plane.

In one particularly preferred configuration, the first spatial light modulator can be formed by a first sub-region of a spatial light modulator, and the second spatial light modulator can be formed by a second sub-region of the same spatial light modulator.

In principle, it is possible for at least one, a plurality or each of the components of first spatial light modulator, second spatial light modulator, spatial light modulator, to be formed by an amplitude-modulating spatial light modulator. It is advantageous, however, if at least one, a plurality or each of the components of first spatial light modulator, second spatial light modulator, spatial light modulator, is or are formed by a phase-modulating spatial light modulator. Phase-modulating spatial light modulators are preferred in general owing to the smaller light losses.

Then at least one, a plurality or each of the components of first spatial light modulator, second spatial light modulator, spatial light modulator, can be formed by a reflective spatial light modulator. However, it is also possible for at least one, a plurality or each of the components of first spatial light modulator, second spatial light modulator, spatial light modulator, to be formed by a transmissive spatial light modulator.

By way of example, at least one, a plurality or each of the components of first spatial light modulator, second spatial light modulator, spatial light modulator, can be formed by one or more of the following components: DMD (Digital Mirror Device), nematic SLM, LCOS display (LCOS=Liquid Crystal on Silicon), variable phase plate, controllable deformable mirror (DM).

The term pupil plane denotes a plane which is perpendicular, in particular with respect to the optical axis of the illumination beam path or of the detection beam path, and which is optically conjugate to a back focal plane of the respective microscope objective. The term intermediate image plane denotes a plane which is perpendicular, in particular with respect to the optical axis of the illumination beam path or of the detection beam path, and which is optically conjugate to an image plane of the respective microscope objective.

When the present description mentions that a component is situated in a pupil plane or in an intermediate image plane, that is always also taken to mean that the relevant component is situated in the vicinity of the respective pupil plane or in the vicinity of the respective intermediate image plane. That is already inherently clear anyway because neither the pupil planes nor the intermediate image planes are planes in the mathematical sense and because the components under consideration here, for example the spatial light modulators and lenses, each have a finite extent in the direction of the optical axis.

In the illumination beam path, for the purpose of varying those locations on or in the sample which are intended to be irradiated with the excitation light, a scanner can be present, for example having galvanometric mirrors or MEMS mirrors which are operated in a quasi-static or resonant fashion. Particularly preferably, the scanner mirrors are arranged in a pupil plane or in the vicinity of a pupil plane of the illumination beam path. However, a scanner is not absolutely necessary for the realization of the invention.

The term controller denotes all hardware and software components which interact with the components of the microscope according to the invention for the intended function thereof. In particular, the control unit can comprise a computing device, for example a PC, and a camera controller. The computer resources of the control unit can be distributed among a plurality of computers and optionally a computer network, in particular also via the Internet. The controller can have in particular customary operating devices and peripherals, such as mouse, keyboard, screen, storage media, joystick, Internet connection. The controller can in particular read the image data from the detector and can also be configured and serve to control the light source. According to the invention, the controller is at least configured to control the first spatial light modulator. If further spatial light modulators are present, the control unit can expediently also be configured for controlling these further light modulators.

Detection light is electromagnetic radiation emitted by the sample illuminated with the excitation light. Emitting means that the detection light comes from the sample. The detection light can be reflected back from the sample or can be light which is transmitted through the illuminated sample. The detection light can typically be, in comparison with the excitation light, red-shifted fluorescent light from fluorescent markers used to prepare the sample.

Commercially available detectors can be used as detectors. Particularly preferably, semiconductor detectors are used. The detector can be in particular a two-dimensionally spatially resolving detector, thus a camera, for example a CCD, CMOS or SPAD array camera. However, for specific microscopy techniques, for example those in which an illumination point or an illumination line is scanned over or through the sample, it is possible to use a punctiform detector, for example a photomultiplier, or a linear detector, for example a CCD or CMOS line array or a linear SPAD array.

The term detection beam path denotes all beam-guiding and beam-modifying optical components, for example objectives, lenses, mirrors, prisms, gratings, filters, stops, beam splitters, modulators, for example spatial light modulators (SLM), by means of which and via which the detection light is guided from the sample to be examined to the detector. The microscope objective of the illumination beam path and the microscope objective of the detection beam path can be one and the same microscope objective. That can be the case for reflected-light microscopy, for example, in which the sample is illuminated and observed from one and the same direction. However, the microscope objective of the illumination beam path can also differ from that of the detection beam path. That is the case for example for transmitted-light microscopy and for reflected-light microscopy in which the sample is illuminated and observed obliquely, as in light sheet microscopy, for example.

The switchable optical functional group can be switchable in particular between exactly two switching states. However, it is also possible for even further switching states to be possible. Examples of the switchable optical functional group are explained below. Particularly preferably, the controller can be configured for switching the optical functional group.

A switchable relay system can be realized by the optical functional group, optionally in interaction with other components installed in the illumination beam path.

The optical functional group can be activatable or arranged downstream of the first spatial light modulator in the illumination beam path. Preferably, in the first switching state and in the second switching state, in each case at least parts of the optical functional group are arranged downstream of the first spatial light modulator in the illumination beam path.

In a first preferred exemplary embodiment, the optical functional group has a changer device having a first and a second lens or it is realized by a changer device having a first and a second lens. The changer device makes it possible to insert the first or the second lens, in particular either the first or the second lens, into the illumination beam path. In this case, in the first switching state, advantageously, a spacing of the first lens inserted into the illumination beam path from the first spatial light modulator and from an intermediate image plane downstream of the first lens can be in each case approximately double the magnitude of a focal length of the lens. Moreover, in the second switching state, a spacing of the second lens from the first spatial light modulator and from an intermediate image plane downstream of the lens can advantageously be in each case approximately equal to the magnitude of a focal length of the second lens, and the second lens together with a tube lens can form a 4f system which images a plane of the first spatial light modulator into a back focal plane of the microscope objective.

In a further advantageous exemplary embodiment, the optical functional group has an adjustable lens or it can be realized by an adjustable lens. In this case, in the first switching state, advantageously, a spacing of the adjustable lens from the first spatial light modulator and from an intermediate image plane downstream of the adjustable lens can be in each case approximately double the magnitude of an adjusted focal length of the adjustable lens. Moreover, in the second switching state, a spacing of the adjustable lens from the first spatial light modulator and from an intermediate image plane downstream of the adjustable lens can be in each case approximately equal to the magnitude of an adjusted focal length of the adjustable lens, and the adjustable lens together with a tube lens can form a 4f system which images a plane of the first spatial light modulator into a back focal plane of the microscope objective.

These two variants can be combined in a preferred variant distinguished by the fact that the optical functional group has an adjustable lens group having an adjustable lens and a lens having a fixed focal length or is realized by a lens group having an adjustable lens and a lens having a fixed focal length. In this case, in the first switching state, a spacing of the adjustable lens group from the first spatial light modulator and from an intermediate image plane downstream of the adjustable lens group can be approximately double the magnitude of an adjusted focal length of the adjustable lens group. Moreover, in the second switching state, a spacing of the adjustable lens group from the first spatial light modulator and from an intermediate image plane downstream of the adjustable lens group can be in each case approximately equal to the magnitude of an adjusted focal length of the adjustable lens group, and the adjustable lens group together with a tube lens can form a 4f system which images a plane of the first spatial light modulator into a back focal plane of the microscope objective.

In the situation of the first switching state in which a spacing of the first lens inserted into the illumination beam path from the first spatial light modulator and from an intermediate image plane downstream of the first lens is in each case approximately double the magnitude of a focal length of the lens, this is also referred to as 2f-2f imaging.

The same applies to the situation of the first switching state in which the spacing of the adjustable lens from the first spatial light modulator and from an intermediate image plane downstream of the adjustable lens is in each case approximately double the magnitude of an adjusted focal length of the adjustable lens, and to the situation in which the spacing of the adjustable lens group from the first spatial light modulator and from an intermediate image plane downstream of the adjustable lens group is approximately double the magnitude of an adjusted focal length of the adjustable lens group.

The 2f-2f imaging introduces a quadratic phase, which can be corrected for example by means of a lens having a positive focal length in the intermediate image plane, thus with a field lens. This last is not absolutely necessary, but can be advantageous if the intention is to avoid vignetting of the beam downstream of the intermediate image plane.

In a further preferred exemplary embodiment of the microscope according to the invention, the optical functional group either in the first switching state or in the second switching state is arranged at least partially, in particular completely, in the illumination beam path downstream of the spatial light modulator, and the optical functional group in the respective other switching state is not part of the illumination beam path. By way of example, the optical functional group can form an alternative beam path having at least one lens, said alternative beam path having a pupil plane and an intermediate image plane, the excitation light either in the first switching state or in the second switching state being guided via the alternative beam path in the direction of the microscope objective.

The optical functional group can have a first switching device, in particular an adjustable first mirror, for the purpose of optionally guiding the excitation light via the alternative beam path of the illumination beam path, and the optical functional group can have a second switching device, in particular an adjustable second mirror, for the purpose of coupling the excitation light from the alternative beam path once again into a main part of the illumination beam path. The mirrors can be formed by customary mirrors, but also by mirror prisms.

The first mirror and the second mirror can be jointly or separately insertable into the illumination beam path and removable therefrom, and further component parts of the optical functional group can remain invariable upon the switching of the optical functional group. By way of example, the mirrors can be optionally pushed into and pushed out of or optionally pivoted into and pivoted out of the illumination beam path.

One particularly preferred exemplary embodiment of the microscope according to the invention is distinguished, however, by the fact that the optically effective component parts of the optical functional group are rigidly connected to one another upon the insertion of the optical functional group into the illumination beam path and upon the removal of the optical functional group. This affords the advantage that upon the switching of the optical functional group, the integrity of the optical functional group per se and thus the optical properties thereof are not affected.

For the purpose of switching the optical functional group, a mechanical drive can expediently be present. The controller can be configured for controlling this drive. The drive can be a rotary drive that enables at least parts of the optical functional group to be moved into or out of the illumination beam path in a pivoting movement. Particularly preferably, the drive can be a linear drive that enables at least parts of the optical functional group to be moved into or out of the illumination beam path in a linear movement.

In one advantageous development of the microscope according to the invention, the optical functional group at the location of a pupil plane is insertable into the illumination beam path between two lenses which form an optical relay when the optical functional group is situated outside the illumination beam path, the relay imaging a plane in which the first spatial light modulator or the second spatial light modulator is arranged into an intermediate image plane of the illumination beam path.

As an alternative thereto, the optical functional group at the location of an intermediate image plane can be insertable into the illumination beam path between a tube lens and a lens, the tube lens and the lens forming an optical relay when the optical functional group is situated outside the illumination beam path, said optical relay imaging a plane in which the first spatial light modulator or the second spatial light modulator is arranged into a pupil plane of the illumination beam path.

In a first particularly preferred variant of the method according to the invention, the optical functional group is controlled in such a way that the first spatial light modulator is situated in a pupil plane or in the vicinity of a pupil plane.

The first spatial light modulator can then be controlled for the purpose of representing a lens having a positive focal length. If this is carried out, it is advantageous if a wavefront manipulator is arranged and/or formed in at least one intermediate image plane or in the vicinity of at least one intermediate image plane of the illumination beam path for the purpose of compensating for distortions of the wavefront of the excitation light that are caused by the first spatial light modulator. The distortions of the wavefront that are to be compensated for are quadratic phase terms of the excitation light in coordinates of the lateral spatial directions (x, y), in particular. In this case, an axial spatial direction (z) is given by an optical axis of the illumination beam path and the two lateral spatial directions are the two spatial directions that are perpendicular to one another and to the direction of the axial spatial direction. The at least one wavefront manipulator can preferably have a positive focal length.

By way of example, a lens having a positive focal length can be arranged in an intermediate image plane or in the vicinity of an intermediate image plane of the illumination beam path for the purpose of compensating for quadratic phase terms of the excitation light in coordinates of the lateral spatial directions (x, y). For the purpose of optionally inserting or removing the glass lens into or from the illumination beam path at the location of the intermediate image plane, a changer device, for example with a suitable mechanical displacement or pivoting device, can be present. Removing the glass lens from the illumination beam path is expedient or necessary if no lens is represented on the first spatial light modulator.

Supplementarily or alternatively, the wavefront manipulator can have one or more of the following components or can be realized partially or completely by one or more of the following components: adjustable lens having a positive focal length, Fresnel lens. The changer device can also have a plurality of glass lenses of varying focal length and one of the glass lenses can in each case be inserted into the intermediate image plane or in the vicinity of the intermediate image plane by the changer device. If an adjustable lens is used as a wavefront manipulator for the purpose of compensating for the quadratic phase, it is advantageous if the adjustable lens is adjustable to a neutral position. The neutral position of the adjustable lens can expediently be adjusted if no lens is represented by the first spatial light modulator in the pupil plane. Supplementarily or alternatively, it is also possible for the controller to be configured to control a second spatial light manipulator in an intermediate image plane downstream of the first spatial light manipulator for the purpose of compensating for the quadratic phase for the purpose of at least partially realizing a Fresnel lens.

Punctiform illuminations or multi-spot illuminations can be realized if so-called tilt and defocus phase patterns are represented on the first spatial light modulator in the pupil plane. For a linear illumination and optionally for a light sheet illumination, the phase pattern of a cylindrical lens can be represented on the first spatial light modulator in the pupil plane.

The first spatial light modulator in the pupil plane can be controlled for example for the purpose of manipulating particles in the sample for the purpose of realizing an optical trap and/or optical tweezers. The basic principle of these techniques is based on the fact that strong focusing of the light in the sample generates strong field gradients in which movable particles are moved in the sample in the direction of the intensive region of the light. As a result, a micro-manipulation of particles can be achieved. By way of example, it is possible to generate a plurality of focal volumes laterally and also axially within the sample by means of the first spatial light manipulator. Examples and details in respect thereof are described in [1], [2].

In further microscopy methods, the first spatial light modulator in the pupil plane can be controlled in such a way that only specific parts of the sample are illuminated. Targeted optical manipulations or stimulations can trigger biological and/or chemical processes in the sample. By way of example, in the so-called FRAP (Fluorescence Recovery After Photobleaching) method, a region of the sample is bleached in a targeted manner by means of an optical manipulation and the time profile of the fluorescence in the bleached region is subsequently examined. That enables conclusions to be drawn in regard to biological processes. A microscopy technique that is known under the keyword optogenetics uses a targeted stimulation of neurons in order to examine processes in a brain, for example a mouse brain. In these microscopy methods, the illumination pattern has to be adapted to the regions to be manipulated/stimulated, the “regions of interest” (ROI). The intensity patterns necessary in each case in the intermediate image plane and thus in the sample plane can be attained in any desired form, in principle, by adjustment of a suitable phase pattern on the first spatial light modulator. The phase patterns to be represented that are necessary in each case can be computed for example using the Gerchberg-Saxton algorithm (computer generated holograms) or a GPC method (GPC=Generalized Phase Contrast). Examples and further details in respect thereof are found in [3], [4], [5].

Furthermore, it is possible for the first spatial light modulator in the pupil plane to be controlled for the purpose of correcting aberrations caused by optical components of the microscope and/or by the sample. It is thereby possible to react flexibly to deteriorations of the optical imaging quality of the microscope on account of system-dictated aberrations which are caused by the optical functional group, for example, but which in particular are also caused by different samples. For such a correction of aberrations, the first spatial light modulator can be controlled using a suitable linear combination of Zernike modes. Details and examples in respect thereof are described in [6], [7]. Owing to the capability of linear superposition of the individual contributions to the electromagnetic fields, this correction of aberrations can also be carried out if the first spatial light modulator is used principally for a different illumination method.

A further variant of the method according to the invention is distinguished by the fact that the first spatial light modulator is controlled for the purpose of defocusing the excitation light in the sample. As an alternative to mechanically moving the microscope objective and/or the sample, it is possible, in order to change a focal plane of the microscope objective within the sample, to carry out defocusing optically with the aid of the first spatial light modulator in the pupil plane. Such technologies are also referred to as remote focusing. By way of example, for this purpose, a phase pattern substantially corresponding to the phase pattern of a Fresnel lens can be represented on the first spatial light modulator. Supplementarily or alternatively, it is also possible to control the first spatial light modulator for the purpose of representing a kinoform lens. Details and examples in respect thereof are described in [8].

In a further preferred variant of the method according to the invention, the first spatial light modulator in the pupil plane can be controlled for STED microscopy for the purpose of shaping the excitation light to form a doughnut beam in the sample. In the STED method (STED=Stimulation Emission Depletion), it is possible to achieve an optical resolution which is greater than that resolution which is given by the diffraction limitation, i.e. the Abbe limit. An essential principle here is that fluorescent molecules are switched on and off in a targeted manner. In the STED method, a laser is then scanned over the sample and excites the dye molecules. A doughnut beam superimposed on the excitation laser converts all molecules, apart from the molecules in the centre of the doughnut ring, to the non-fluorescent ground state by way of stimulated emission. The doughnut beam required for the STED method can be generated by means of a spatial light modulator in the pupil plane, in which case a vortex phase pattern then has to be represented on the light modulator. Details in respect thereof and examples are described in [9].

In further variants of the method according to the invention, the optical functional group is controlled in such a way that the first spatial light modulator is situated in an intermediate image plane or in the vicinity of an intermediate image plane.

By way of example, the first spatial light modulator in the intermediate image plane can be controlled for the purpose of representing illumination patterns in regions of the back focal plane of the microscope objective which are sufficiently far away from an optical axis that a TIRF condition is satisfied for the excitation light in the sample. In the TIRF method (TIRF=Total Internal Reflection Fluorescence), the excitation light is radiated onto the sample at an angle of incidence relative to the optical axis which is greater than the angle for total internal reflection when light undergoes transition from an optically denser medium, i.e. comprising a medium having a larger refractive index n, to an optically less dense medium, i.e. a medium having a smaller refractive index n. That has the effect that fluorescence is excited in a thin region in the vicinity of the coverslip and a high surface sensitivity is thus achieved. That is also referred to as sectioning. The large angles of incidence relative to the optical axis correspond to points in the objective pupil which are comparatively far away from the optical axis. In microscopes, the TIRF condition can be attained by tilting a mirror or a linear phase pattern in a plane that is conjugate to the intermediate image. Details in respect thereof and examples are described in [11].

In a further variant of the method according to the invention, the first spatial light modulator in the intermediate image plane is controlled for the purpose of representing a phase grating for the purpose of carrying out SIM microscopy. SIM methods (SIM=Structured Illumination Microscopy) use grating illumination with subsequent computer-based calculation in order to obtain an increase in resolution. The grating illumination is generated by a phase grating in a plane that is conjugate to the intermediate image. Details in respect thereof and examples are described in [12].

Owing to the capability of linear superposition of the individual contributions to the electromagnetic fields, variants are also possible in which the TIRF method is combined with SIM methods. These methods are referred to as TIRF-SIM methods and use the structured illumination for the purpose of increasing the resolution, and the surface sensitivity, i.e. the sectioning, of TIRF. Specifically, the first spatial light modulator is controlled for the purpose of representing a phase grating in an intermediate image plane, grating orders of the phase grating in the back focal plane of the microscope objective being sufficiently far away from the optical axis that a TIRF condition is satisfied in the sample. Details and examples in respect thereof are found in [13], [14].

With a spatial light modulator arranged in an intermediate image plane, in particular with a phase modulator, it is also possible to achieve a light sheet illumination if the phase modulator is controlled with a chequered phase pattern with rows each becoming narrower towards the edge. A light sheet illumination generated in this way is known under the keywords lattice light sheet.

Further advantageous variants of the method according to the invention are possible if a second spatial light modulator is arranged in the illumination beam path, and the optical functional group either is controlled such that the first spatial light modulator is situated in a pupil plane or in the vicinity of a pupil plane and the second spatial light modulator is situated in an intermediate image plane or in the vicinity of an intermediate image plane, or is controlled such that the first spatial light modulator is situated in an intermediate image plane or in the vicinity of an intermediate image plane and the second spatial light modulator is situated in a pupil plane or in the vicinity of a pupil plane. In this case, the second light modulator can be arranged downstream of the first spatial light modulator in the illumination beam path, or vice versa.

An intensity of the excitation light in the sample can be varied by virtue of the fact that the first spatial light modulator or second spatial light modulator localized in a pupil plane or in the vicinity of a pupil plane or in an intermediate image plane or in the vicinity of an intermediate image plane diffracts at least one portion of the excitation light into a region located outside a region through which the optical system propagates, the portion being varied by variation of a diffraction efficiency of the spatial light modulator respectively used, and the diffraction efficiency being varied by variation of a contrast of a phase grating adjusted in the spatial light modulator respectively used. Details in respect thereof and examples are described in [10], [15], [16]. Owing to the capability of linear superposition of the individual contributions to the electromagnetic fields, this adjustment of the intensity can also be carried out if the first spatial light modulator or the second spatial light modulator is in each case used principally for a different illumination method.

Finally, GPC methods (GPC=General Phase Contrast) are also possible with the method according to the invention. In this case, the first spatial light modulator in the intermediate image plane can be controlled for the purpose of representing a phase pattern of the image to be imaged, and the second spatial light modulator can be controlled for the purpose of representing a phase contrast filter, for example a rectangular or round phase mask, with a phase deviation of π for low spatial frequencies. An intensity profile of the image to be imaged can then be recovered from interference of phase-shifted low spatial frequencies and non-modulated higher spatial frequencies. Examples and details in respect thereof are described in [18], [19].

A first spatial light modulator, for example in a pupil plane, and/or a second spatial light modulator, for example in an intermediate image plane, can manipulate an intensity and a phase of the excitation light in the sample. In this case, in the illumination beam pass, a phase modulation can be carried out first in a pupil plane and then downstream in an intermediate image plane. That is described for example in [17]. It is also possible to carry out a phase modulation in the illumination beam path first in an intermediate image plane and then in a pupil plane downstream thereof.

Further advantages and features of the invention are explained below with reference to the figures, in which:

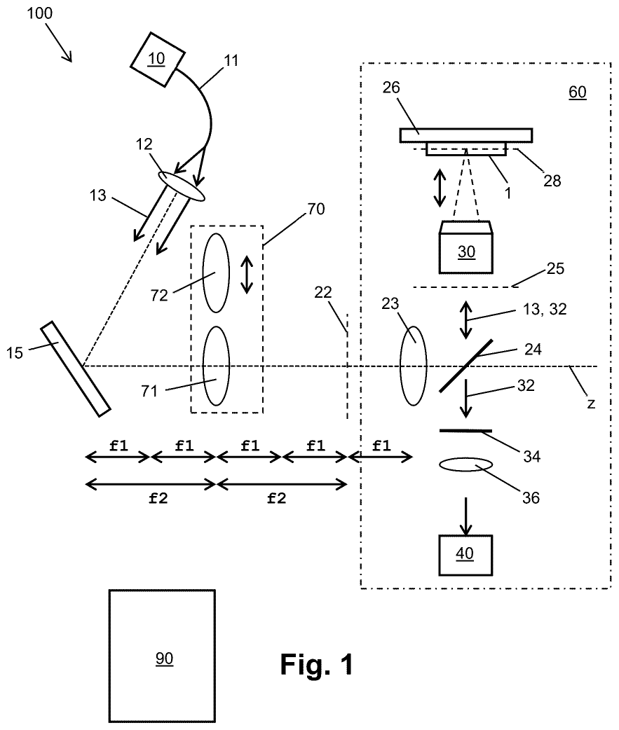

FIG. 1: shows a schematic illustration of a first exemplary embodiment of a microscope according to the invention;

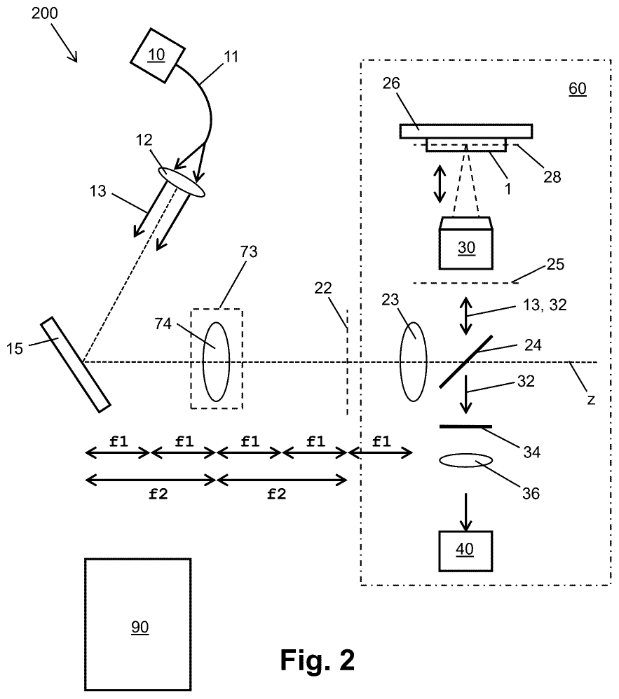

FIG. 2: shows a schematic illustration of a second exemplary embodiment of a microscope according to the invention;

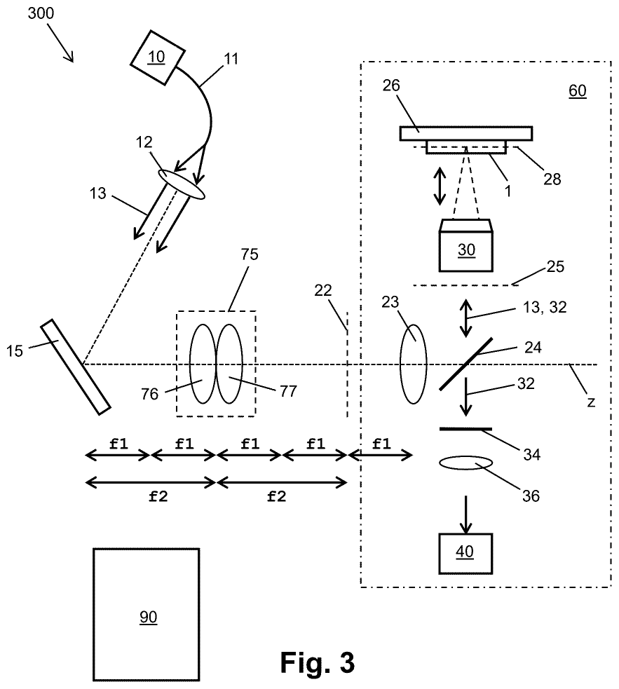

FIG. 3: shows a schematic illustration of a third exemplary embodiment of a microscope according to the invention;

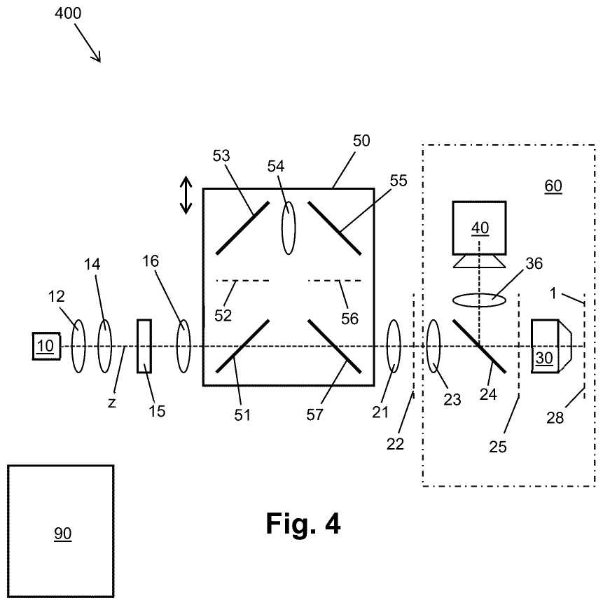

FIG. 4: shows a schematic illustration of a fourth exemplary embodiment of a microscope according to the invention in a first operating state;

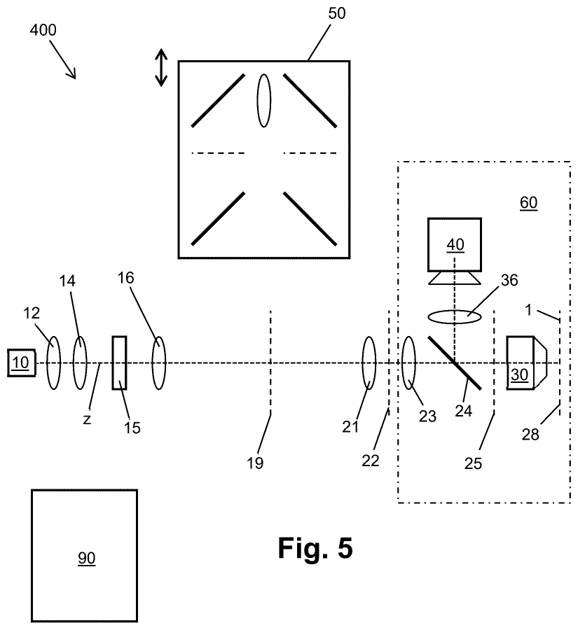

FIG. 5: shows the microscope from FIG. 4 in a second operating state;

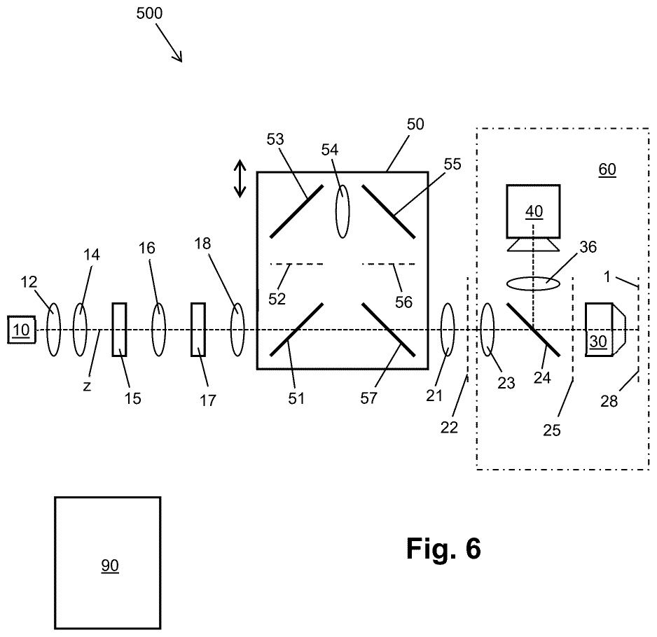

FIG. 6: shows a schematic illustration of a fifth exemplary embodiment of a microscope according to the invention in a first operating state;

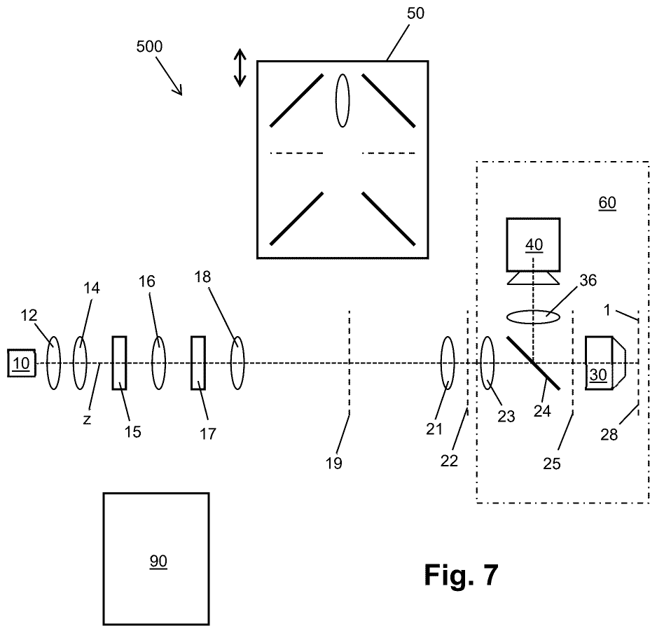

FIG. 7: shows the microscope from FIG. 6 in a second operating state;

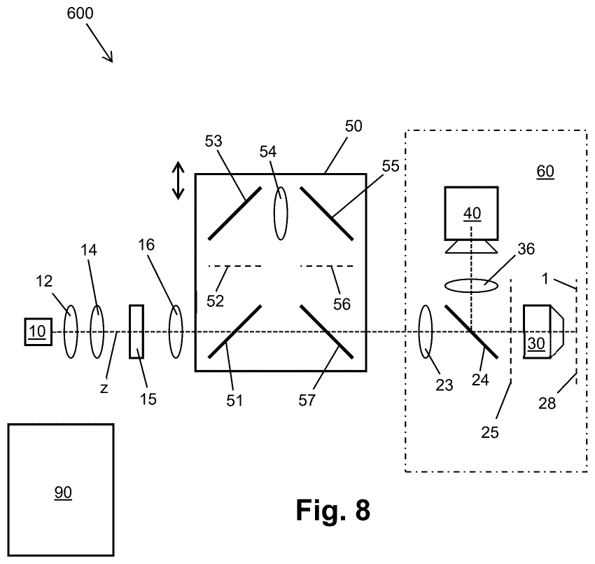

FIG. 8: shows a schematic illustration of a sixth exemplary embodiment of a microscope according to the invention in a first operating state; and

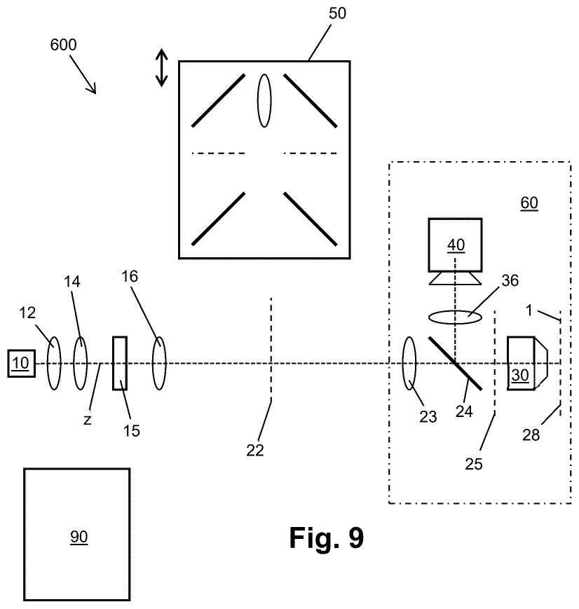

FIG. 9: shows the microscope from FIG. 8 in a second operating state.

Identical and identically acting components are generally provided with the same reference signs in the figures.

A first exemplary embodiment of a multimodal microscope 100 according to the invention will be explained with reference to FIG. 1. Variants of the microscope 100 will then be described with reference to FIGS. 2 and 3.

The multimodal microscope 100 shown schematically in FIG. 1 serves for examining a sample 1 and has firstly a light source 10 for transmitting excitation light 13 and an illumination beam path for guiding the excitation light 13 onto the sample 1 to be examined. At least one first spatial light modulator 15 is present in the illumination beam path for the purpose of manipulating the excitation light 13. In the exemplary embodiment shown in FIG. 1, the first spatial light modulator 15 is the sole spatial light modulator and can preferably be a reflective phase-modulating SLM, for example an LCOS display. Finally, a component part according to the invention of the illumination beam path is a microscope objective 30. In the exemplary embodiment shown, the illumination beam path additionally has a tube lens 23 and a main beam splitter 24.

Detection light 32 emitted by the sample 1 owing to illumination with the excitation light 13 is detected by a detector 40 present according to the invention. In the exemplary embodiment shown, the detector 40 can be a camera, i.e. a pixelated two-dimensionally spatially resolving detector. However, that is not mandatory. It is also possible to use detectors which consist of a single pixel, for example photomultipliers or SPADs, or of a line array of pixels, for example a CMOS, CCD or SPAD line array. The detection light 32 is guided onto the detector 40 via a detection beam path. In the exemplary embodiment shown, the microscope objective 30 is part of the detection beam path. However, that is not mandatory. The detection beam path can also have a separate microscope objective. In the exemplary embodiment shown, the detection beam path additionally has the main beam splitter 24, an emission filter 34 and a tube lens 36. The detector 40 can be situated in an intermediate image plane of the detection beam path, in particular.

A controller 90, for example a PC, is present for the purpose of controlling at least the first spatial light modulator 15. The controller 90 can also serve for controlling further components of the microscope 100 and for evaluating measurement data of the camera 40. The controller 90 is operatively connected to the components which it serves to control and whose measurement data it evaluates, the connection being effected by cables, for example, which are not illustrated in the figure.

According to the invention, in the case of the microscope 100 in FIG. 1, a switchable optical functional group 70 is present, which is switchable at least into a first switching state and into a second switching state. In the exemplary embodiment shown in FIG. 1, the optical functional group is realized by a changer device 70 having a first lens 71 and a second lens 72. In the case of the optical functional group 70, the two switching states according to the invention are realized by virtue of the fact that either the first lens 71 or the second lens 72 is inserted into the illumination beam path by the changer device.

According to the invention, the first spatial light modulator 15 is situated either in an intermediate image plane or in the vicinity of an intermediate image plane of the illumination beam path or in a pupil plane or in the vicinity of a pupil plane of the illumination beam path, depending on which switching state the optical functional group 70 is in.

The excitation light 13 from the light source 10 passes via an optical fibre 11 firstly to a lens 12, which serves for collimating the excitation light. The collimated beam of the excitation light 13 is then incident on the first spatial light modulator 15 and is reflected by the latter in the direction of the first lens 71 situated in the beam path, subsequently passes through the intermediate image plane 22 and is guided via a tube lens 23 and a main beam splitter 24 in the direction of the microscope objective 30, which guides, for example focuses, the excitation light 13 into a sample plane 28 in the sample 1. A sample holder 26 serves for holding the sample 1. A microscope assembly is identified by the reference sign 60.

In the situation illustrated in FIG. 1, the first lens 71 is situated in the illumination beam path and the first switching state is realized. An optical axis of the illumination beam path in the region of the first lens 71 is identified by z. A spacing of the first lens 71 from the first spatial light modulator 15 and from an intermediate image plane 22 downstream of the first lens 71 is in each case approximately double the magnitude of a focal length f1 of the lens 71. That means that the intermediate image plane 22 and the plane of the spatial light modulator 15 in the first switching state are optically conjugate and that the spatial light modulator 15 is accordingly situated in an intermediate image plane of the illumination beam path. All the methods described above in which the excitation light is manipulated in an intermediate image plane can then be carried out in this switching state. By way of example, the excitation light can be manipulated for the purpose of realizing TIRF or SIM methods or combinations thereof. Since the spacing of the plane in which the spatial light modulator 15 is situated and the spacing of the intermediate image plane 22 from the lens 71 is in each case approximately double the magnitude of the focal length f1 of the lens 71, this is also referred to as 2f-2f imaging. This introduces a quadratic phase, which can be corrected for example by means of a lens having a positive focal length in the intermediate image plane, thus with a field lens. This last is not absolutely necessary, but can be advantageous if the intention is to avoid vignetting of the beam downstream of the intermediate image plane.

In the situation—not shown in FIG. 1—in which the second lens 72 is situated in the illumination beam path, the second switching state is realized. A spacing of the second lens 72 from the first spatial light modulator 15 and from an intermediate image plane 22 downstream of the second lens 72 is then in each case approximately equal to the magnitude of a focal length f2 of the second lens 72, and the second lens 72 together with the tube lens 23 forms a 4f system which images a plane of the first spatial light modulator 15 into a back focal plane 25 of the microscope objective 30. That means that the back focal plane 25 of the microscope objective 30 and the plane of the spatial light modulator 15 in the second switching state are optically conjugate and that the spatial light modulator 15 is accordingly situated in a pupil plane of the illumination beam path.

The first spatial light modulator can then be controlled for example for the purpose of representing a lens having a positive focal length. If this is carried out, it may be expedient, as described above for the 2f-2f imaging, to position a glass lens having a positive focal length in the intermediate image plane 22, for example, in order to compensate for quadratic phase terms of the excitation light in coordinates of the lateral spatial directions x, y, said phase terms resulting from the generation of the lens having a positive focal length on the first spatial light modulator. Details in respect thereof are found in the general part of the description. Removing this glass lens from the intermediate image plane 22 is expedient or necessary if no lens is represented on the first spatial light modulator 15.

In the second switching state, i.e. when the first spatial light modulator 15 is situated in a pupil plane, for example optical tweezers or optical traps can be realized and FRAP, STED and many further methods are possible. Details in respect thereof are found in the general part of the description.

The second exemplary embodiment of a microscope 200 according to the invention as illustrated schematically in FIG. 2 differs from the microscope 100 in FIG. 1 merely in the optical functional group. Instead of the changer device 70 having the two lenses 71 and 72, an optical functional group 73 is realized by an adjustable lens 74 in the example in FIG. 2.

In a first switching state, namely a first adjustment state, the adjustable lens 74 is adjusted to a focal length of f1. A spacing of the adjustable lens 74 from the first spatial light modulator 15 and from an intermediate image plane 22 downstream of the adjustable lens 74 is in each case approximately double the magnitude of this adjusted focal length f1 of the adjustable lens 74. That means that the intermediate image plane 22 and the plane of the spatial light modulator 15 in the first switching state are optically conjugate and that the spatial light modulator 15 is accordingly situated in an intermediate image plane of the illumination beam path. All the methods described above in which the excitation light is manipulated in an intermediate image plane can then once again be carried out in this switching state.

In a second switching state, namely a second adjustment state, the adjustable lens is adjusted to a focal length of f2, which is double the magnitude of the focal length f1 adjusted for the first switching state. The spacing of the adjustable lens 74 from the first spatial light modulator 15 and from the intermediate image plane 22 downstream of the adjustable lens 74 is then in each case approximately equal to the magnitude of the adjusted focal length f2 of the adjustable lens 74, and the adjustable lens 74 together with the tube lens 23 forms a 4f system which images the plane of the first spatial light modulator 15 into the back focal plane 25 of the microscope objective 30. That means that the back focal plane 25 of the microscope objective 30 and the plane of the spatial light modulator 15 in the second switching state are optically conjugate, that is to say that the spatial light modulator 15 is situated in a pupil plane of the illumination beam path. All the methods described above in which the excitation light is manipulated in a pupil plane can then once again be carried out in this switching state.

The third exemplary embodiment of a microscope 300 according to the invention as illustrated schematically in FIG. 3 differs from the microscope 100 in FIG. 1 merely in the optical functional group. Instead of the changer device 70 having the two lenses 71 and 72, the optical functional group is realized by an adjustable lens group 75 having an adjustable lens 76 and a lens 77 having a fixed focal length in the example in FIG. 3.

In a first switching state, namely a first adjustment state, the adjustable lens 76 is adjusted such that the lens group 75 as a whole realizes a focal length of f1. A spacing of the adjustable lens group 75 from the first spatial light modulator 15 and from the intermediate image plane 22 downstream of the adjustable lens 74 is in each case approximately double the magnitude of this adjusted focal length f1 of the adjustable lens group 75. That means that the intermediate image plane 22 and the plane of the spatial light modulator 15 in the first switching state are optically conjugate and that the spatial light modulator 15 is accordingly situated in an intermediate image plane of the illumination beam path. All the methods described above in which the excitation light is manipulated in an intermediate image plane can be carried out in the first switching state.

In a second switching state, namely a second adjustment state, the adjustable lens 76 is adjusted such that the lens group 75 as a whole realizes a focal length of f2, which is double the magnitude of the focal length f1 adjusted for the first switching state. The lens 77 having a fixed focal length can have a focal length of f2, for example. In the second switching state, the adjustable lens 76 is then set to a neutral position, such that only the focal length of the lens 77 is effective. The spacing of the adjustable lens group 75 from the first spatial light modulator 15 and from the intermediate image plane 22 downstream of the adjustable lens 74 is then in each case approximately equal to the magnitude of the adjusted focal length f2 of the adjustable lens group 75, and the adjustable lens group 75 together with the tube lens 23 forms a 4f system which images the plane of the first spatial light modulator 15 into the back focal plane 25 of the microscope objective 30. That means that the back focal plane 25 of the microscope objective 30 and the plane of the spatial light modulator 15 in the second switching state are optically conjugate and that the spatial light modulator 15 is thus situated in a pupil plane of the illumination beam path. All the methods described above in which the excitation light is manipulated in a pupil plane can then be carried out in the second switching state. The lens 77 having a fixed focal length can preferably be an achromatic lens. This affords the advantage that chromatic effects can be corrected, which is not possible in the case of the example in FIG. 2.

Further exemplary embodiments of the multimodal microscope according to the invention will be described with reference to FIGS. 4 to 9.

Whereas at least one component of the optical functional group is always part of the illumination beam path in each switching state in the exemplary embodiments in FIGS. 1 to 3, that is not the case in the exemplary embodiments in FIGS. 4 to 9. In the exemplary embodiments shown therein, an optical functional group in each case in the first switching state or in the second switching state is arranged completely in the illumination beam path downstream of the spatial light modulator 15, and in the respective other switching state it is not part of the illumination beam path.

The components in the assembly 60 in FIGS. 4 to 9 correspond to the components which have been explained above in association with FIG. 1, and will not be described again here. For reasons of clarity, FIGS. 4 to 9 do not show all component parts in the assembly 60.

Firstly, a fourth exemplary embodiment of a multimodal microscope 400 according to the invention will be described in association with FIGS. 4 and 5. FIG. 4 shows the microscope 400 in a first switching state, in which an optical functional group 50 is part of the illumination beam path, and FIG. 5 shows the same microscope 400 in a second switching state, in which the optical functional group 50 has been removed from the illumination beam path.

In the case of the multimodal microscope 400 according to the invention as shown in a first switching state in FIG. 4, excitation light 13 from the light source 10 is firstly collimated by the lens 12 and is then guided by a lens 14 onto a first spatial light modulator 15. The lenses 12 and 14 serve for expanding the laser beam to an aperture of the first spatial light modulator 15. In the exemplary embodiment shown in FIGS. 4 and 5, the first spatial light modulator 15 is once again the sole spatial light modulator and can preferably be a transmissive phase-modulating SLM, for example an LCOS display. In FIG. 4, the first spatial light modulator 15 is followed by a lens 16, the optical functional group 50 present according to the invention, and a lens 21.

The optical functional group 50 provides an alternative beam path having an intermediate image plane 52 and a pupil plane 56. As viewed in the direction of the illumination beam path, the optical functional group has a first mirror 51, which guides the excitation light 13 coming from the lens 16 into the alternative beam path. The alternative beam path then leads via the intermediate image plane 52 to a first internal mirror 53, which guides the excitation light 13 via a lens 54 and a second internal mirror 55 to a second mirror 57, via which the excitation light 13 is again incoupled into a main part of the illumination beam path and is guided in the direction of the lens 21.

In the exemplary embodiment shown, the optically effective component parts 51, 53, 54, 55, 57 of the optical functional group 50 are rigidly connected to one another, i.e. the optical functional group as a whole can be inserted into the illumination beam path and removed therefrom. However, that is not mandatory. Byway of example, provision could also be made for only the mirrors 51 and 57 to be rigidly coupled to one another, in which case this structural unit could then optionally be inserted into the illumination beam path or be removed therefrom. The components 53 to 55 could then be arranged in a spatially fixed manner.

For the purpose of switching the optical functional group, hence for the purpose of moving the optical functional group 50 into and out of the illumination beam path, a mechanical drive of fundamentally known nature can expediently be present. This mechanical drive can preferably be controlled by the controller 90.

In the situation shown in FIG. 5, the optical functional group 50 is in the second switching state, which is realized by virtue of the optical functional group 50 being situated outside the illumination beam path. In this situation, a relay optical unit is realized by the lenses 16 and 21, and images a plane in which the first light modulator 15 is arranged into an intermediate image plane 22 of the illumination beam path. A pupil plane 19 is formed between the lens 16 and the lens 21, essentially at the location at which the optical functional group 50 can be inserted, and a further light modulator can optionally be arranged in said pupil plane. The first light modulator 15 is thus situated in an intermediate image plane. All the methods described above in which the excitation light is manipulated in an intermediate image plane can be carried out in this switching state.

In the situation shown in FIG. 4, the optical functional group 50 is in the first switching state, which is realized by virtue of the optical functional group 50 being situated in the illumination beam path. In this situation, the back focal plane 25 of the microscope objective 30 is imaged into the plane 56 within the optical functional group 50 by the tube lens 23 and the lens 21, i.e. the plane 56 is a pupil plane. Furthermore, the lens 16 together with the lens 54 of the optical functional group 50 forms a relay optical unit, which images the plane in which the first light modulator 15 is arranged into the pupil plane 56. The first light modulator 15 is thus situated in a pupil plane in FIG. 4. All the methods described above in which the excitation light is manipulated in a pupil plane can be carried out in this switching state.

A fifth exemplary embodiment of a multimodal microscope 500 according to the invention will be described with reference to FIGS. 6 and 7. The optical functional group 50 used there is the same as the one described in association with FIGS. 4 and 5. FIG. 6 shows the microscope 500 in a first switching state, in which the optical functional group 50 is part of the illumination beam path, and FIG. 7 shows the same microscope 500 in a second switching state, in which the optical functional group 50 has been removed from the illumination beam path.

The fifth exemplary embodiment of the microscope 500 differs from the fourth exemplary embodiment in FIGS. 4 and 5 merely in that a second spatial light modulator 17 and a further lens 18 are arranged directly downstream of the lens 16. The second spatial light modulator 17 is once again preferably a transmissive phase modulator, for example an LCOS display.

In the state which is shown in FIG. 6 and in which the optical functional group 50 is situated in the illumination beam path, the tube lens 23 again together with the lens 21 forms a relay optical unit, which images the back focal plane 25 of the microscope objective 30 into the plane 56, such that the plane 56 is a pupil plane. Furthermore, the lens 18 together with the lens 54 of the optical functional group 50 forms a relay optical unit, which images the plane in which the second spatial light modulator 17 is arranged into the pupil plane 56. The second spatial light modulator 17 is thus situated in a pupil plane in FIG. 6. The lens 21 together with the lens 54 then forms a relay optical unit, which images the intermediate image plane 22 into the plane 52. The plane 52 thus is an intermediate image plane. Finally, the lens 16 together with the lens 18 forms a relay optical unit, which images the plane in which the first spatial light modulator 15 is arranged into the intermediate image plane 52. The first spatial light modulator 15 is accordingly arranged in an intermediate image plane. In the case of this arrangement, therefore, all method variants for microscopy are possible in which the excitation light 13 is manipulated in the illumination beam path first in an intermediate image plane, i.e. by means of the first spatial light manipulator 15 in the example shown, and subsequently in a pupil plane, that is to say by means of the second spatial light manipulator 17.

In the state shown in FIG. 7, the optical functional group 50 is not situated in the illumination beam path. The tube lens 23 together with the lens 21 then forms a relay optical unit, which images the back focal plane 25 of the microscope objective 30 into the pupil plane 19. Furthermore, the lens 18 together with the lens 21 forms a relay optical unit, which images the plane in which the second spatial light modulator 17 is arranged into the intermediate image plane 22. The second spatial light modulator 17 is thus situated in an intermediate image plane in FIG. 7. Finally, the lens 16 together with the lens 18 forms a relay optical unit, which images the plane in which the first spatial light modulator 15 is arranged into the pupil plane 19. The first spatial light modulator 15 is accordingly arranged in a pupil plane 19 in FIG. 7. In the case of this arrangement, therefore, all method variants for microscopy are possible in which the excitation light 13 is manipulated in the illumination beam path first in a pupil plane, i.e. by means of the first spatial light manipulator 15 in the example shown, and subsequently in an intermediate image plane, that is to say by means of the second spatial light manipulator 17. The lens 21 could be omitted in FIGS. 6 and 7. The consequence of that would be the respective interchange of the roles of intermediate image planes and pupil planes in the illumination beam path upstream of the intermediate image plane 22, i.e. what is an intermediate image plane with the lens 21 becomes a pupil plane without the lens 21, and vice versa.

A sixth exemplary embodiment of a multimodal microscope 600 according to the invention will be described with reference to FIGS. 8 and 9. The optical functional group 50 used there is once again the same as the one described in association with FIGS. 4 and 5. FIG. 8 shows the microscope 600 in a first switching state, in which the optical functional group 50 is part of the illumination beam path, and FIG. 9 shows the same microscope 600 in a second switching state, in which the optical functional group 50 has been removed from the illumination beam path. The sixth exemplary embodiment of the microscope 600 differs from the fourth exemplary embodiment in FIGS. 4 and 5 merely in that the lens 21 is not present.

In the state which is shown in FIG. 8 and in which the optical functional group 50 is situated in the illumination beam path, the tube lens 23 together with the lens 54 of the optical functional group 50 forms a relay optical unit, which images the back focal plane 25 of the microscope objective 30 into the plane 52, such that the plane 52 in FIG. 8 is a pupil plane. In FIG. 8, the plane 56 is an intermediate image plane upstream of the tube lens 23. Furthermore, the lens 16 together with the lens 54 of the optical functional group 50 forms a relay optical unit, which images the plane in which the first spatial light modulator 15 is arranged into the intermediate image plane 56. The first spatial light modulator 15 is accordingly arranged in an intermediate image plane in FIG. 8. In the case of this arrangement, therefore, all method variants for microscopy are possible in which the excitation light 13 is manipulated in an intermediate image plane in the illumination beam path.

In the state shown in FIG. 9, the optical functional group 50 is not situated in the illumination beam path. The tube lens 23 together with the lens 16 then forms a relay optical unit, which images the back focal plane 25 of the microscope objective 30 into the plane in which the first spatial light modulator 15 is arranged. The first spatial light modulator 15 is accordingly arranged in a pupil plane in FIG. 9. In the case of this arrangement, therefore, all method variants for microscopy are possible in which the excitation light 13 is manipulated in a pupil plane in the illumination beam path.

In the situation in FIGS. 4, 5, 6, 7 and 9, as described above, the spatial light modulator arranged in a pupil plane in each case can be controlled for the purpose of representing a lens having a positive focal length. If this is carried out, it is expedient to position a glass lens in each case in the intermediate image plane 22, in order to compensate for quadratic phase terms of the excitation light in coordinates of the lateral spatial directions x, y, said phase terms resulting from the generation of the lens having a positive focal length on the first spatial light modulator. Details in respect thereof are found in the general part of the description. Removing this glass lens from the intermediate image plane 22 is expedient or necessary if no lens is represented on the spatial light modulator in the pupil plane.

### LIST OF REFERENCE SIGNS

1 sample
10 light source, laser
11 optical fibre
12 lens, collimation lens
13 excitation light
14 lens
15 first spatial light modulator, first phase modulator
16 lens
17 second spatial light modulator, second phase modulator
18 lens
19 pupil plane
21 lens
22 intermediate image plane
23 tube lens
24 main beam splitter
25 back focal plane of microscope objective 30, pupil plane, objective pupil
26 sample holder
28 focal plane in sample 1
30 microscope objective
32 light reflected back from sample 1
34 emission filter
36 tube lens in the detection beam path
40 detector, camera
50 optical functional group, introducible and withdrawable as a whole
51 first mirror
52 intermediate image plane or pupil plane
53 first internal mirror
54 lens
55 second internal mirror
56 pupil plane or intermediate image plane
57 second mirror
60 microscope assembly
70 changer device, optical functional group
71 first lens having focal length f1
72 second lens having focal length f2
73 optical functional group
74 adjustable lens
75 optical functional group
76 lens having fixed focal length, e.g. f2
77 adjustable lens
90 controller, PC
100 first exemplary embodiment of microscope according to the invention
200 second exemplary embodiment of microscope according to the invention
300 third exemplary embodiment of microscope according to the invention
400 fourth exemplary embodiment of microscope according to the invention
500 fifth exemplary embodiment of microscope according to the invention
600 sixth exemplary embodiment of microscope according to the invention
f1 focal length of lens 71
f2 focal length of lens 72=2×f1

### REFERENCES

[1] U.S. Pat. No. 7,835,051B2
[2] Alexander Jesacher, Severin Furhapter, Stefan Bernet, and Monika Ritsch-Marte; Diffractive optical tweezers in the Fresnel regime. 12, 10 OPTICS EXPRESS 2243 (2004)
[3] U.S. Ser. No. 10/568,516B2
[4] L Golan, I Reutsky, N Farah and S Shoham; Design and characteristics of holographic neural photo-stimulation systems. J. Neural Eng. 6 066004 (2009)
[5] Emiliano Ronzitt, Cathie Ventalon, Marco Canepari, Benoit C Forget, Eirini Papagiakoumou and Valentina Emiliani; Recent advances in patterned photostimulation for optogenetics. J. Opt. 19 113001 (2017)
[6] U.S. Pat. No. 9,891,172B2
[7] Jinhan Ren, Kyu Young Han; 2.5D microscopy with polarization independent SLM for enhanced detection efficiency and aberration correction. 29, 17/16/Optics Express 27530 (2021)
[8] U.S. Ser. No. 11/665,324B2
[9] Pierre Mahou, Nathan Curry, Dorothea Pinotsi, Gabriele Kaminski Schierle, and Clemens Kaminski “Stimulated emission depletion microscopy to study amyloid fibril formation”, Proc. SPIE 9331, Single Molecule Spectroscopy and Superresolution Imaging VIII, 93310U (2015)
[10] Jeffrey A. Davis, Keevin Olea Valade'z, and Don M. Cottrell; Encoding amplitude and phase information onto a binary phase-only spatial light modulator. 42, 11 APPLIED OPTICS (2003)
[11] U.S. Pat. No. 9,915,815B2
[12] U.S. Pat. No. 9,829,690B2
[13] Reto Fiolka, Markus Beck, and Andreas Stemmer; Structured illumination in total internal reflection fluorescence microscopy using a spatial light modulator. 33, 14 OPTICS LETTERS 1629 (2008)
[14] Young, L. J., Ströhl, F., Kaminski, C. F. A Guide to Structured Illumination TIRF Microscopy at High Speed with Multiple Colors. J. Vis. Exp. (111), e53988, doi:10.3791/53988 (2016).
[15] Clark, “Comparison of beam generation techniques using a phase only spatial light modulator”, Opt. Expr. 24/6, 6249, 2016
[16] Yoshiki Nakata, Kazuhito Osawa and Noriaki Miyanaga; Utilization of the high spatial-frequency component in adaptive beam shaping by using a virtual diagonal phase grating. Scientific Reports 9, 4640 (2019)
[17] U.S. Pat. No. 9,778,573B2
[18] Andrew Banas and Jesper Gluckstad; Light Shaping with Holography, GPC and Holo-GPC. Opt. Data Process. Storage 3:20-40 (2017)
[19] Alexander Jesacher, Christian Maurer, Andreas Schwaighofer, Stefan Bernet and Monika Ritsch-Marte; Near-perfect hologram reconstruction with a spatial light modulator. 16, 4 OPTICS EXPRESS 2597 (2008)
[20] CN106094189B
[21] Christian Maurer, Alexander Jesacher, Stefan Bernet, and Monika Ritsch-Marte; What spatial light modulators can do for optical microscopy. Laser Photonics Rev. 5, No. 1, 81-101 (2011)

1. Multimodal microscope comprising:
a light source for transmitting excitation light,
an illumination beam path having a microscope objective for guiding the excitation light onto and/or into a sample to be examined, at least one first spatial light modulator being present in the illumination beam path for manipulating the excitation light,
a detector for detecting detection light emitted by the sample owing to illumination with the excitation light,
a detection beam path, comprising the microscope objective or a further microscope objective, for guiding the detection light onto the detector,
a controller at least for controlling the first spatial light modulator, and
a switchable optical functional group, which is switchable at least into a first switching state and into a second switching state,
wherein the first spatial light modulator is situated either in an intermediate image plane or in the vicinity of an intermediate image plane of the illumination beam path or in a pupil plane or in the vicinity of a pupil plane of the illumination beam path, depending on which switching state the optical functional group is in.

2. Microscope according to claim 1,
wherein the optical functional group has at least one of: a changer device having a first lens and a second lens or is realized by a changer device having a first lens and a second lens; an adjustable lens or is realized by an adjustable lens; or an adjustable lens group having an adjustable lens and a lens having a fixed focal length or is realized by a lens group having an adjustable lens and a lens having a fixed focal length.

3. (canceled)

5. Microscope according to claim 2,
wherein in the first switching state one of the following features is realized:
a spacing of the first lens from the first spatial light modulator and from an intermediate image plane downstream of the first lens is in each case approximately double the magnitude of a focal length of the lens;
a spacing of the adjustable lens from the first spatial light modulator and from an intermediate image plane downstream of the adjustable lens is in each case approximately double the magnitude of an adjusted focal length of the adjustable lens;
a spacing of the adjustable lens group from the first spatial light modulator and from an intermediate image plane downstream of the adjustable lens group is approximately double the magnitude of an adjusted focal length of the adjustable lens group.

6. Microscope according to claim 2,
wherein in the second switching state one of the following features is realized:
a spacing of the second lens from the first spatial light modulator and from an intermediate image plane downstream of the second lens is in each case approximately equal to the magnitude of a focal length of the second lens, and
the second lens together with a tube lens forms a 4f system which images a plane of the first spatial light modulator into a back focal plane of the microscope objective;
a spacing of the adjustable lens from the first spatial light modulator and from an intermediate image plane downstream of the adjustable lens is in each case approximately equal to the magnitude of an adjusted focal length of the adjustable lens, and
the adjustable lens together with a tube lens forms a 4f system which images a plane of the first spatial light modulator into a back focal plane of the microscope objective;
a spacing of the adjustable lens group from the first spatial light modulator and from an intermediate image plane downstream of the adjustable lens group is in each case approximately equal to the magnitude of an adjusted focal length of the adjustable lens group, and the adjustable lens group together with a tube lens forms a 4f system which images a plane of the first spatial light modulator into a back focal plane of the microscope objective.

7. Microscope according to claim 1,
wherein the optical functional group either in the first switching state or in the second switching state is arranged at least partially in the illumination beam path downstream of the spatial light modulator, and
wherein the optical functional group in the respective other switching state is not part of the illumination beam path.

8. Microscope according to claim 7,
wherein the optical functional group forms an alternative beam path having at least one lens, said alternative beam path having a pupil plane and an intermediate image plane,
the excitation light either in the first switching state or in the second switching state being guided via the alternative beam path in the direction of the microscope objective.

9. Microscope according to claim 7,
wherein the optical functional group has a first switching device for guiding the excitation light via the alternative beam path, and
wherein the optical functional group has a second switching device for coupling the excitation light from the alternative beam path once again into a main part of the illumination beam path.

10. Microscope according to claim 7,
wherein the first mirror and the second mirror are jointly insertable into the illumination beam path and removable therefrom, and wherein further component parts of the optical functional group remain invariable upon the switching of the optical functional group.

11. Microscope according to claim 7,
wherein the optically effective component parts of the optical functional group are rigidly connected to one another upon the insertion of the optical functional group into the illumination beam path and upon the removal of the optical functional group.

12. Microscope according to claim 1,
wherein a second spatial light modulator is arranged in the illumination beam path, which is situated in or in the vicinity of a pupil plane when the first spatial light modulator is situated in or in the vicinity of an intermediate image plane, and which is situated in or in the vicinity of an intermediate image plane when the first spatial light modulator is situated in or in the vicinity of a pupil plane.

13. Microscope according to claim 12,
wherein the first spatial light modulator is formed by a first sub-region of a spatial light modulator, and wherein the second spatial light modulator is formed by a second sub-region of the same spatial light modulator.

14. Microscope according to claim 7,
wherein the optical functional group at the location of a pupil plane is insertable into the illumination beam path between two lenses which form an optical relay when the optical functional group is situated outside the illumination beam path, the optical relay imaging a plane in which the first spatial light modulator or the second spatial light modulator is arranged into an intermediate image plane of the illumination beam path.

15. Microscope according to claim 7,
wherein the optical functional group at the location of an intermediate image plane is insertable into the illumination beam path between a tube lens and a lens, the tube lens and the lens forming an optical relay when the optical functional group is situated outside the illumination beam path, said optical relay imaging a plane in which the first spatial light modulator or the second spatial light modulator is arranged into a pupil plane of the illumination beam path.

16. Microscope according to claim 1,
wherein a lens having a positive focal length is arranged or arrangeable in an intermediate image plane or in the vicinity of an intermediate image plane of the illumination beam path for compensating for quadratic phase terms of the excitation light in coordinates of the lateral spatial directions.

17. Method for microscopy, comprising:
guiding excitation light onto and/or into a sample to be examined, via an illumination beam path having a microscope objective, manipulating the excitation light at least by a first spatial light modulator in the illumination beam path,
guiding detection light emitted by the sample owing to illumination with the excitation light onto a detector via a detection beam path comprising the microscope objective or a further microscope objective,
detecting the detection light by said detector,
switching a switchable optical functional group either into a first switching state or into a second switching state before microscope measurements are carried out,
the first spatial light modulator, depending on the switching state into which the optical functional group is switched, being situated either in an intermediate image plane or in the vicinity of an intermediate image plane of the illumination beam path or in a pupil plane or in the vicinity of a pupil plane of the illumination beam path, and
wherein afterwards at least one of the spatial light modulators is controlled for providing a desired illumination mode.

18. Method according to claim 17,
wherein the optical functional group is controlled in such a way that the first spatial light modulator is situated in a pupil plane or in the vicinity of a pupil plane.

19. Method according to claim 18,
wherein the first spatial light modulator is controlled for at least one of: manipulating particles in the sample for realizing an optical trap and/or optical tweezers; correcting aberrations caused by optical components of the microscope and/or by the sample; defocusing the excitation light in the sample; or STED microscopy for shaping the excitation light to form a doughnut beam in the sample.

20. Method according to claim 18,
wherein the first spatial light modulator is controlled in such a way that only specific parts of the sample are illuminated.

21-23. (canceled)

24. Method according to claim 17,
wherein the optical functional group is controlled in such a way that the first spatial light modulator is situated in an intermediate image plane or in the vicinity of an intermediate image plane.

25. Method according to claim 24,
wherein the first spatial light modulator is controlled for at least one of: representing illumination patterns in regions of the back focal plane of the microscope objective which are sufficiently far away from an optical axis that a TIRF condition is satisfied for the excitation light in the sample or representing a phase grating in an intermediate image plane for carrying out SIM microscopy.

26. (canceled)

27. Method according to claim 18,
wherein a second spatial light modulator is arranged in the illumination beam path, and wherein the optical functional group either is controlled such that the first spatial light modulator is situated in a pupil plane or in the vicinity of a pupil plane and the second spatial light modulator is situated in an intermediate image plane or in the vicinity of an intermediate image plane,
or is controlled such that the first spatial light modulator is situated in an intermediate image plane or in the vicinity of an intermediate image plane and the second spatial light modulator is situated in a pupil plane or in the vicinity of a pupil plane.

28. Method according to claim 27,
wherein an intensity of the excitation light in the sample is varied by virtue of the fact that the first spatial light modulator or second spatial light modulator localized in a pupil plane or in the vicinity of a pupil plane diffracts at least one portion of the excitation light into a region located outside a region through which the optical system propagates, the portion being varied by variation of a diffraction efficiency of the spatial light modulator respectively used, and the diffraction efficiency being varied by variation of a contrast of a phase grating adjusted in the spatial light modulator respectively used.

29. Method according to claim 27,
wherein the first spatial light modulator in the intermediate image plane is controlled for representing a phase pattern of the image to be imaged, and
wherein the second spatial light modulator is controlled for representing a phase contrast filter with a phase deviation of π for low spatial frequencies, and wherein an intensity profile of the image to be imaged is recovered from interference of phase-shifted low spatial frequencies and non-modulated higher spatial frequencies.

30. Method according to claim 27,
wherein the first spatial light modulator and/or the second spatial light modulator manipulate(s) an intensity and a phase of the excitation light in the sample.
